(19) United States
(12) Patent Application Publication
(10) Pub. No.: US 2002/0161856 A1
(43) Pub. Date: Oct. 31, 2002

(54) Method and apparatus for remote processing and sharing of digital images

(76) Inventors: Richard A. Pineau, No. Andover, MA (US); John W. Lynch, Melrose, MA (US); Nick W. Werthessen, Millis, MA (US)

Correspondence Address: Orlando Lopez, POLAROID CORPORATION, Patent Department, 784 Memorial Drive, Cambridge, MA, 02139, US

(21) Appl. No.: 09/842,754

(22) Filed: Apr. 26, 2001

(51) Int. Cl. G06F 15/16

(52) U.S. Cl. 709/219; 709/233; 709/237

(57) ABSTRACT

An apparatus and method for enabling the remote printing or storing or sharing, at a node in a data communications network, of digital images from an image data source provided by a customer and of identifying information, the identifying information stored in a storage component in the apparatus. The apparatus comprises means for accessing one image or a plurality of images from the image data source, means for automatically determining a closest entry point into the data communications network, and means for transmitting the image or plurality of images and the customer identifying information, through the entry point, to a remote node of the network. Methods to ensure the efficient and reliable transmission are disclosed. Databases for maintaining, at a remote location, image data provided by a customer and other data relating to the customer and for enabling the sharing of image products are also disclosed.

### BACKGROUND OF THE INVENTION

1. Field Of the Invention

The present invention relates to the use of digital image acquisition devices. More specifically, it relates to a method and apparatus to enable the remote printing, storing or sharing of digital images.

2. Background Description

The introduction of digital cameras has expanded the possibilities for camera users. The users of the digital cameras have the ability to display and review images after acquisition and, subsequently, select those images that they want to retain. Digital images are easily transferred to a different storage device, which allows for ease of sharing and image manipulation. However, the present model for the use of digital cameras resembles more the model of a PC peripheral than the model for the use of photographic cameras. The images, after acquisition and selection, are stored in the local memory of the digital camera. Once all the available space in the memory is used for storage of the digital images, the images have to be transferred to another storage device such as a PC. The user is then practically tethered to a PC or must use removable memories, such as Compact Flash cards or floppy disks, in the camera and then transfer the images from the removable memories to the PC. If the user desires to obtain hard copy output from the digital images or to share the images, the user must transfer to images to a location where hard copy output can be obtained or from which the images can be shared. The transfer of the images is effected either by physically transporting the removable memory to a location where hard copy output can be obtained or by transferring the images to a PC and, subsequently, uploading the images to a remote node of a communication network where hard copy output can be obtained or from which the images can be shared.

Several solutions have been proposed to enhance the capabilities of digital cameras. Hull et al., in U.S. Pat. No. 5,806,005 (Jonathan J. Hull, et al., U.S. Pat. No. 5,806,005, Wireless Transfer From a Digital Still Video Camera to a Networked Computer, Sep. 8, 1998), disclose a digital camera with a cellular telephone transmitter. The Ricoh RDC-i700 digital camera allows the user to FTP upload images to a web site or e-mail images or to transfer images to a PC connected to a modem. A similar system, a digital camera with a modem, is disclosed by Van Ryzin (John M. Van Ryzin, WIPO Publication WO 00/48384, A System and Method for Transmitting and Receiving Digital Picture Images from a Digital camera to One or More Remote Locations, Aug. 17, 2000). Steinberg, et al. (Eran Steinberg, et al., WIPO Publication WO 00/01138, Camera Network Communication Device, Jan. 6, 2000) disclose a device for connecting a digital camera to a communication network for downloading data to a remote computer. If the device is incorporated into the camera, the resulting camera is the same as a camera with a modem.

In these solutions, if the camera user were located in a different telephone area code than the remote computer or server to which the user desires to download the images, the user would incur a toll charge. Depending on the rate structure and the time duration for the telephone call, the toll charge could be significant.

Other solutions are also costly and those costs have to borne by or passed back to the users of digital cameras who upload images via the infrastructure. The users of digital cameras who desire to obtain hard copy output from the digital images or to share the images are not provided the opportunity to transmit the images to a remote node of a communication network through an automatically determined closest entry point.

### SUMMARY OF THE INVENTION

It is the primary object of this invention to provide an apparatus and method that enables the users of digital image acquisition devices to obtain hard copy output from or to share the digital images by transmitting the images to a remote node of a communication network through an automatically determined closest entry point.

It is another object of this invention to enable the transmission of the images to the remote node of a communication network to occur at the fastest data rate.

It is also another object of this invention to enable the transmission of the images to be interrupted and restarted.

A further object of this invention is to enable the transmission of the images, after interruption and restart, to restart with the image datum immediately following the last image datum received at the remote node.

To achieve these and other objects, one aspect of the invention includes an apparatus for enabling the remote printing or storing or sharing, at a node in a data communications network, of digital images from an image data source provided by a customer and of identifying information, the identifying information stored in a storage component in the apparatus. The apparatus comprises means for accessing one image or a plurality of images from the image data source, means for automatically determining a closest entry point into the data communications network, and means for transmitting the image or plurality of images and the customer identifying information, through the entry point, to a remote node of the network. The identifying information could be preset in the apparatus or, in another aspect of the invention, the apparatus further comprises means for receiving the identifying information.

Another aspect of this invention is a method of utilizing the means provided by the apparatus to print, store, or share, at a remote node in a data communications network, digital images from an image data source provided by a customer. Still another aspect of this invention is a method of utilizing the means provided by the apparatus to print, store, or share, at a remote node in a data communications network, digital images from an image data source provided by a customer wherein the transmission of an image or plurality of images from the apparatus to the remote node of the communication network comprises steps to ensure that the transmission occurs at the highest possible data rate.

A further aspect of this invention is a method of utilizing means provided by the apparatus to print, store, or share, at a remote node in a data communications network, digital images from an image data source provided by a customer wherein the transmission of an image or plurality of images from the apparatus to the remote node of the communication network comprises further steps to allow detecting an interruption and restarting transmission after the interruption.

Another aspect of this invention is a method of utilizing the means provided by the apparatus to print, store, or share, at a remote node in a data communications network, digital images from an image data source provided by a customer wherein the transmission of an image or plurality of images from the apparatus to the remote node of the communication network comprises further steps to synchronize a transmission event with the receiving node so that transmission can remote node.

Still other aspects of this invention relate to databases for maintaining, at a remote location, image data provided by a customer and other data relating to the customer and for enabling the sharing of image products.

The method and systems of this invention allow the users of digital cameras to upload the digital images to a remote node of a communication network through an automatically determined closest entry point thereby being able to print, share or store the images from any location with access to a communication port (such as a telephone connection). The user of the digital camera does not need to connect the camera or the removable memory to a computer with appropriate drivers and transmit the images from the computer to the remote node of the communication network. Neither does the user of the digital camera need to incur excessive telephone toll charges in connecting to the network or pay for additional network infrastructure.

### DESCRIPTION OF THE DRAWINGS

The novel features that are considered characteristic of the invention are set forth with particularity in the appended claims. The invention itself, however, both as to its organization and its method of operation, together with other objects and advantages thereof will be best understood from the following description of the illustrated embodiment when read in connection with the accompanying drawings wherein:

FIG. 1 depicts a graphical representation of an embodiment of the system that enables printing, storing, or sharing at a remote node in a data communications network, of digital images from an image data source provided by a customer;

FIGS. 2A, and 2B depict a flowchart of an embodiment of the method that enables printing, storing, or sharing at a remote node in a data communications network, of digital images from an image data source provided by a customer;

FIG. 3 depicts a block diagram of selected components of an embodiment of the apparatus of this invention for enabling the remote printing or storing, at a node in a data communications network, of digital images from an image data source provided by a customer;

FIG. 4 depicts a flowchart of an embodiment of the method that ensures that the transmission of image or plurality of images from the apparatus to the remote node of the communication network occurs at the highest possible data rate;

FIG. 5 depicts a flowchart of an embodiment of the method that enables detecting an interruption and restarting transmission after the interruption;

FIG. 6 depicts a flowchart of an embodiment of the method that enables the synchronization of a transmission even t with the receiving node so that transmission can restart at the image datum immediately following the last datum received at the remote node;

FIG. 7 depicts a graphical representation of an embodiment of the server at the remote node of the network wherein the representation illustrates selected databases;

FIG. 8 illustrates the contents of an embodiment of the image database;

FIG. 9 illustrates the contents of an embodiment of the database that contains data related to the apparatus and the customer;

FIG. 10 illustrates the contents of another embodiment of the database that contains data related to the apparatus and the customer.

### DETAILED DESCRIPTION

To enable consumers to obtain hard copy or digital copy output from or to share digital images by transmitting the images to a remote node of a communication network through an automatically determined closest entry point. A system and method are disclosed whereby the customer is provided with a specific apparatus, hereafter called a communications center, having identifying information stored in a memory therein, wherein one or more images and said the identifying information are transmitted to at a remote node of a communication network through an automatically determined closest entry point. The image or plurality of images have been accessed from the image data source and have been transferred from the image data source to the communication center. Other aspects of this invention that enable the transmission to occur at the highest possible data rate, enable detecting an interruption and restarting transmission after the interruption, and enable synchronizing a transmission event with the receiving node so that transmission can restart at the datum subsequent to the last datum received at the remote node are disclosed. Databases for maintaining, at a remote location, image data provided by a customer and other data relating to the customer and for enabling the sharing of image products are also disclosed.

### The System and Method

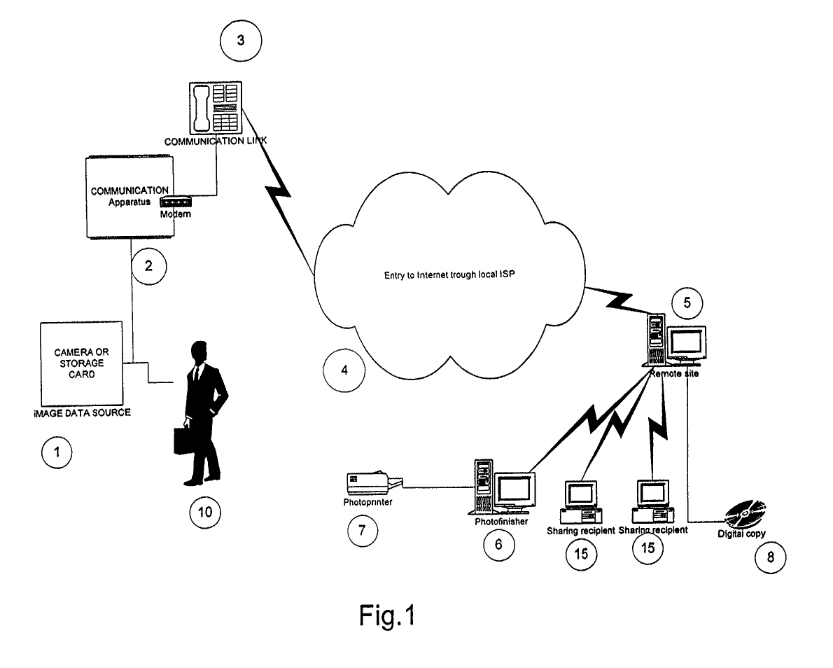

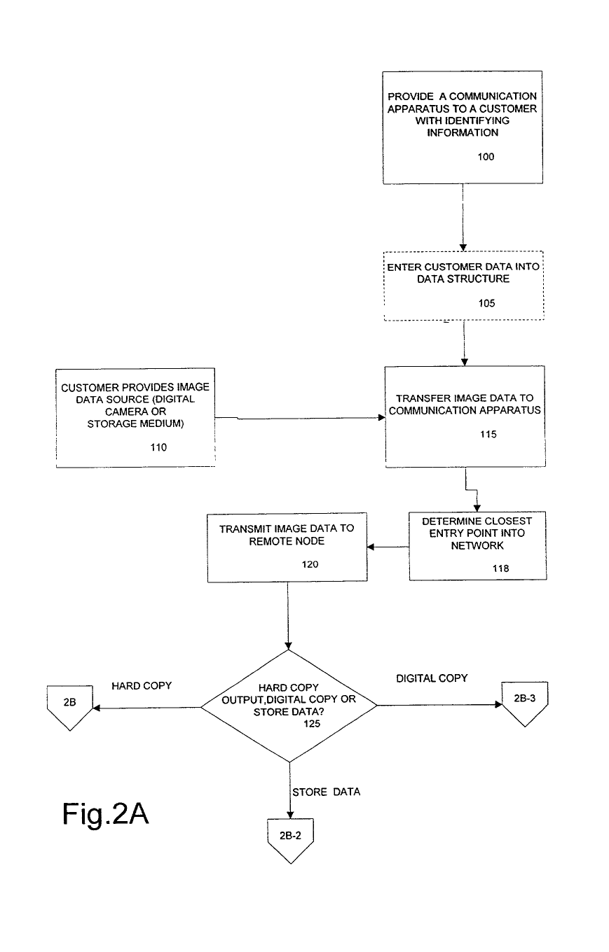

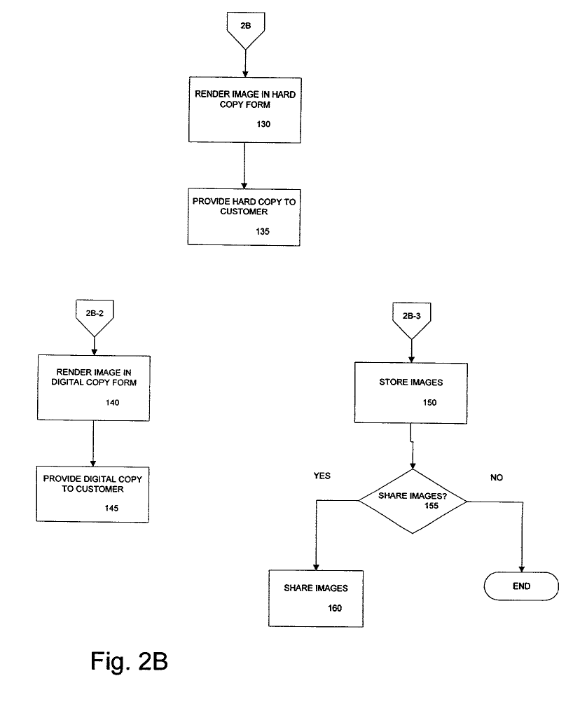

Referring to FIGS. 1, 2A and 2B, a customer 10 utilizes an image acquisition device (not shown) to acquire images and stores the image data in a data source 1, such as the storage area of the image acquisition device or a storage medium such as a Compact flash card, Memory Stick, PCMCIA card or a floppy or CD-R disk (step 110). The customer 10 is provided with a communication center 2 wherein the center has identifying information (step 100). Customer related data can be entered into a data structure (also not shown) located in a storage device (also not shown) at the remote node of the network 5 at the time that the customer 10 obtains the communication center 2 (step 105). The image data is then transferred from to the communication center 2 (step 115). The transfer of the image data from the data source 1 to the communication center 2 occurs when after it has been detected that the data source 1 is connected to the communication center 2. A processor (not shown) in the communication center 2 executes program code (also not shown), in a well known manner, to transfer the image data from the data source 1 to the communication center 2. The communication center 2 then executes operations to determine a closest entry point into the network 4 (step 118). The operations used to determine the closest entry point will be fully explained below when the communication center 2 is described. The image in data is then transmitted to a remote node of a network via a communication link 3 through the closest entry point, such as a local ISP in the case where the network is the Internet (step 120). As part of the operations of the communications center 2, the image and identifying data is structured according to the required protocol for the network. The communication link 3 can be a wired link, such as a telephone line or a network line, or it could be a wireless link. Either as part of the customer related data entered into a data structure in step 105 or by means of entering data through the user interface controls (not shown) in the commnunication apparatus center 2. The consumer indicates whether hard copy output, digital copy output or image sharing (or a combination of these options) is desired (step 125). If hard copy is desired, the image data is sent to a photofinisher 6 where it is printed in a photo printer 7 (step 130). It should be apparent that the photofinisher 6 and photo printer 7 can be located at the same location as the remote site server 5 or at a different node of the network. The hard copy is then provided to the customer or to recipients specified by the customer (step 135). If digital copy is desired, the image data is placed in a removable storage medium 8 such as a recordable CD (CD-R or CD-RW), a ZIP™ disk, or one or several floppy disks (step 140). The digital copy is then provided to the customer or to recipients specified by the customer (step 145). Additionally, the image data could be entered into an image database also not shown) and stored (step 150). If image sharing is desired (step 155), the image data is shared with recipients 15 specified by the customer (step 160).

### The Communication Center

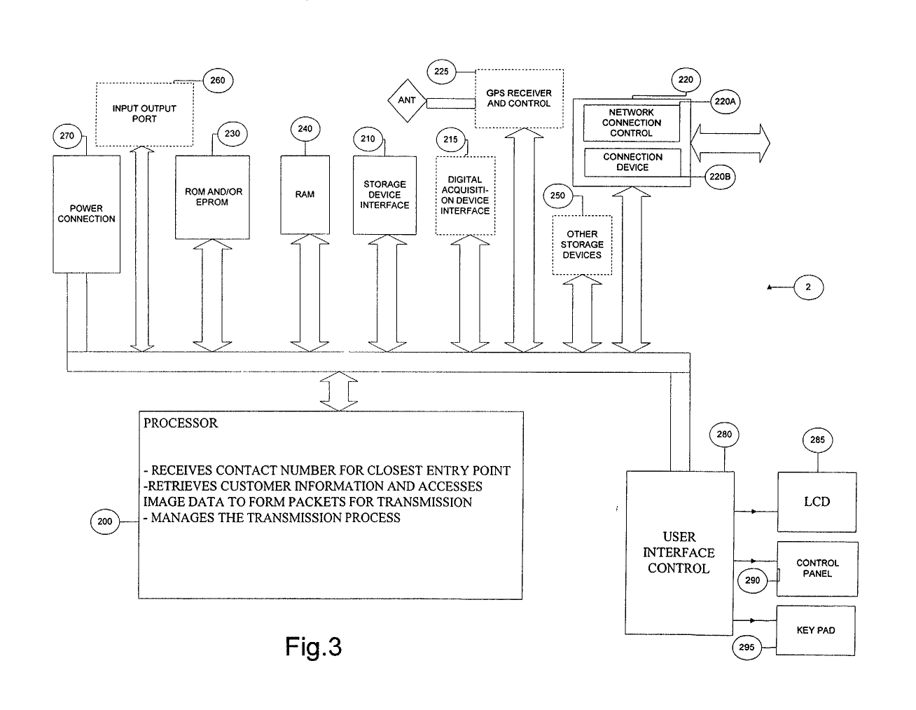

Referring to FIG. 3, selected components of an embodiment of the communication center 2 are shown in block form. It should be apparent to those skilled in the digital arts that a processor based system includes other components which are a well known part of a digital design such as components that provide information that can provide date and time information (such as a system clock). Processor 200 performs the operations to manage the accessing of one image or a plurality of images from the image data source 1, manage the automatic determination of a closest entry point into the data communications network 4, and manage the transmission of the image or plurality of images and the identifying information, through the entry point, to a remote node of the network 5.

Unique identifying information is associated with each communication center 2. The identifying information is stored in ROM or EPROM 230 or in other storage devices 250, such as flash memory, in the communication center 2. The identifying information can be preset in the center by means well known in the art. In the case of preset identifying information, the identifying information can be modified either by modifying the memory in the case of EPROMs or replacing the memory in the case of ROMs. Alternatively, the input/output port 260 provides means for receiving the identifying information. If the identifying information is loaded through the input/output port 260, it is stored in non-volatile storage 250 such as flash memory. Input/output port 260 can be a serial port, a USB port or other input/output ports well known in the state of the art. The writing to storage occurs under control of the processor 200 by means well known in the art. Other uses of means of receiving identifying information are well known in the art (for example, setting information into cellular telephones). Identifying information can include an identifying number or address for the communications center as well as customer identifying information and information such as the date and time of transmission. The customer can interact with the communications center 2 by means of the user interface controls 280 and user interface devices comprising an LCD 285, a control panel 290 and a keypad 295. It should be apparent that the communications center 2 can include some or all of the user interface devices as well as other user interface device well known in the art. The computer instructions for accessing the identifying information reside in either the ROM or EPROM 230 or the RAM 240 or other storage 250 such as a flash memory. The method for accessing information from memory is well known to those skilled in the art.

A storage device interface 210 or a digital acquisition device interface 215, along with the required driver software (not shown) provide means for accessing one image or a plurality of images from the image data source 1. One or both interfaces would be included in the communication center 2. The driver software would be stored in the storage device 250, such as flash memory, a disk drive, an EPROM or stored in RAM 240. Other configurations will be apparent to those skilled in the art and these are to be included in the spirit of the present invention. The driver software could be installed during the assembly and setup of the communication center 2. Alternatively, the methods described in commonly assigned U.S. patent application Ser. No. 09/ 653,597, filed on Aug. 31, 2000, entitled “Web Based File Upload System”, hereby incorporated by reference herein, can be used to upload driver software and application software (or an “applet”) to transfer the data from the image data source 1 to the communication center 2 or to the remote server 5.

A network connection control and connection device module 220 implements means for transferring information to a network. The preferred embodiment of a connection device is a modem. However, other possible devices are an Ethernet adapter, a router, a hub, an infrared link or any wireless connection, depending on the network used and the mode of communicating to the network. It should be apparent that a modem could be a wireless modem. The network connection control interfaces between connection device (such as the modem) and the processor 200. The methods of accessing a network from a computer are well known to those skilled in the art.

In order to automatically determine the closest entry point into the data communications network 4, the processor 200 can initiate a call though the network connection control 220A and connection device (modem) 220B to a toll free number which has been previously established. At the location of the toll free number (not shown), a computer (also not shown) performs operations to recognize the location of the communication center 2 through caller ID, to locate the closest entry point into the data communications network 4 from comparison of the location of the communication center 2 and a stored list of locations of entry points into the data communications network 4, and to transmit back to the communication center 2 (through the connection device 220B) the contact information (phone number or network address, for example) of the closest entry point into the data communications network 4. In the configuration where the data communications network 4 is the Internet, the toll free telephone service would, in one embodiment, be provided by a national ISP service (AOL or ATT.net, for example). Alternatively, a GPS receiver and control module 225 could be used to ascertain the location of the communication center 2. Comparing the location of the communication center 2 as determined from the GPS receiver to a stored list of locations of entry points into the data communications network (not shown) will provide the contact information (phone number or network address, for example) of the closest entry point into the data communications network 4. (The list of locations of entry points into the data communications network could be stored in ROM or EPROM 230 or in other storage 250 such as a flash memory.) Other means for automatically determining the closest entry point into the data communications network 4, in addition to the ones described above, include comparing the location of the communication center 2 to a stored list of locations of entry points into the data communications network when the location of the communication center is known or accessing a preset (in ROM, EPROM or flash memory) contact information of the closest entry point into the data communications network when the location of the communication center is known. The computer code for managing and implementing the process of receiving data comprising the contact information for the closest entry point into the data communications network resides in either the ROM or EPROM 230 or the RAM 240 or other storage 250 such as a flash memory. The methods for communicating between two computers or comparing items in memory are well known to those skilled in the art.

Upon automatically determining the closest entry point into the data communications network 4, the image or plurality of images and the identifying information are transmitted to a remote node of the network through the entry point by means of the network connection device 220B under control of the processor 200. The computer code for establishing communication with the closest entry point into the data communications network and transferring the images and identifying information resides in either the ROM or EPROM 230 or the RAM 240 or other storage 250 such as a flash memory. The method for establishing communication between a computer and a point in a network is known to those skilled in the art.

In an alternate configuration in which the methods described in commonly assigned U.S. patent application Ser. No. 09/653,597, filed on Aug. 31, 2000, entitled “Web Based File Upload System”, are used to upload driver software and application software (or an “applet”), upon automatically determining the closest entry point into the data communications network 4, connection to a remote node of the network is established through the entry point. Then, driver software and application software (or an “applet”) are loaded onto the communication center 2. The application software manages and implements the transfer of the image or plurality of images and identifying information to a remote node of the network. Additionally, the methods described in commonly assigned U.S. patent application Ser. No. 09/653,597 constitute an embodiment of means for installing operating files in the communication center 2.

### Methods for Efficient Reliable Transmission

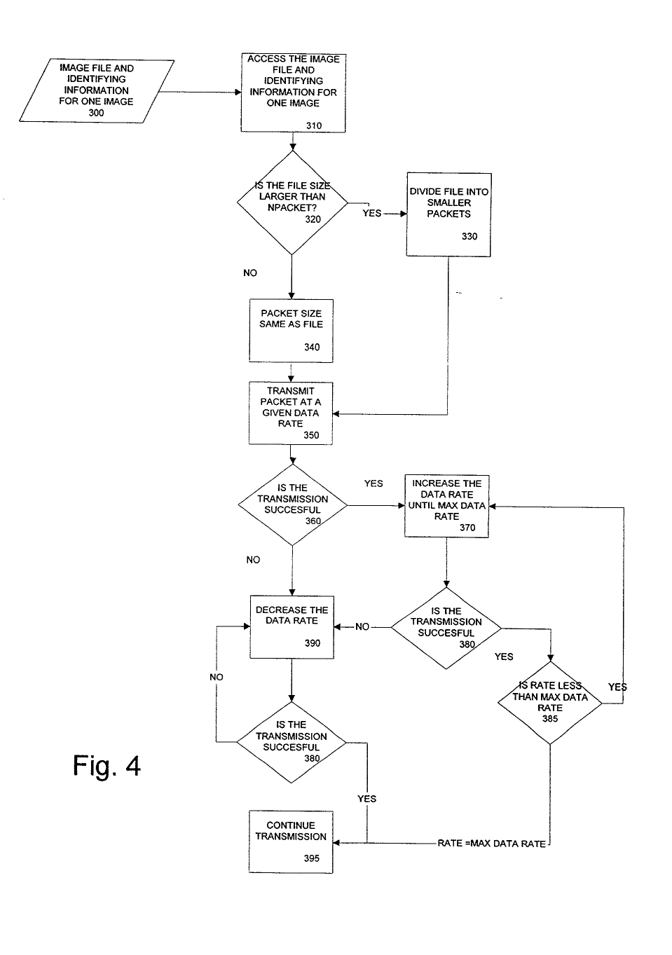

The communications center 2 described above includes the processor 200 that can execute computer readable code to optimize or automate functions. The ability to automate functions allows for the development of methods for efficient and reliable transmission. FIG. 4 depicts a flowchart of an embodiment of the method that ensures that the transmission of one or more images from the communications center 2 to the remote node of the communication network 5 occurs at the highest possible data rate. The method starts with a predetermined packet size, Npacket, and a predetermined data rate, Data rate₀. An image file containing one image and identifying information (if any) is accessed by the processor 200 (step 310) in the first step. The size of the image file is compared to the predetermined packet size, Npacket (step 320). If the file size is smaller than or equal to the predetermined packet size, the packet size to be transmitted is the same as the file size (step 340). If the file size is larger than the predetermined packet size, the file is divided into packets of size Npacket (step 330 ). If necessary to ensure that the sum of packet sizes equals the file size, one packet of smaller size is formed (step 330). The above steps constitute an embodiment of means for constructing at least one of a plurality of packets of data wherein the data in the at least one of a plurality of packets comprises the image data for at least one image and the identifying information. The first packet is transmitted at the predetermined data rate, Data rate₀ (step 350). If the transmission is successful, the communication center 2 receives a confirmation of successful transmission from the remote node 5. Upon positive determination of the success of the transmission (step 360) (when the transmission is successful) the data rate is increased by a predetermined amount, Δ (step 370), until a predetermined maximum data rate is reached. If the calculated data rate exceeds the maximum data rate, the data rate is set to the maximum data rate. The next packet is transmitted and the success of the transmission is determined (step 380) and the process repeats until the maximum rate is reached or all the images are transmitted.

If the transmission is not successful, the data rate is decreased by the predetermined amount, Δ (step 390). The next packet is transmitted and the success of the transmission is determined (step 380). If the transmission is successful, transmission continues at the data rate determined in the previous step (step 395). If the transmission is not successful, the data rate is decreased by the predetermined amount, Δ (step 390). Steps 380 and 390 are repeated until successful transmission is achieved. It should be apparent that other embodiments of the above method can be implemented, for example, starting at the maximum data rate and reducing upon unsuccessful transmission or starting at a lowest data rate and increasing the data rate upon successful transmission. The computer readable code that details the above method resides in either the ROM or EPROM 230 or the RAM 240 or other storage 250 such as a flash memory or other computer readable medium. It should be apparent to one skilled in the art how to convert the flowchart to a detailed computer readable code.

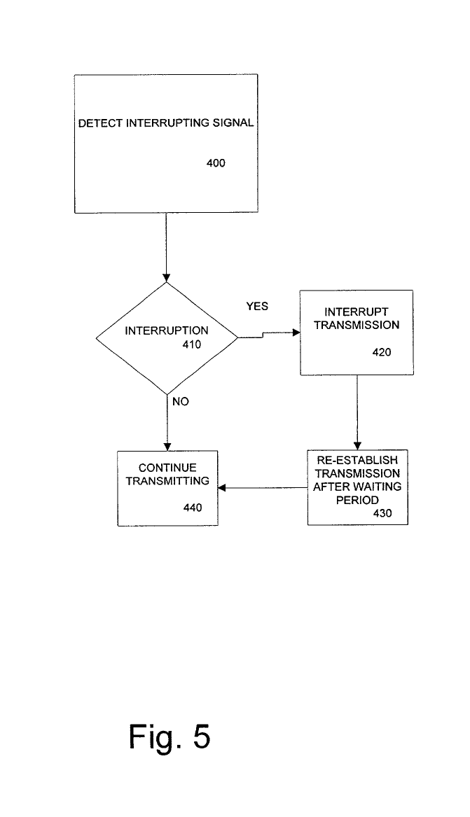

Ensuring the reliability of transmission requires providing means to account for interrupting signals such as call interrupt, incoming calls. FIG. 5 depicts a flowchart of an embodiment of the method that enables detecting an interruption and restarting transmission after the interruption. The process starts with the detection of the presence of an interrupting signal during transfer of the at least one of a plurality of packets of data (step 400). Means for identifying the presence of an interrupting signal during transfer of at least one of a plurality of packets of data generates a signal to the processor. The actual implementation of such means will differ for different connection devices 220 but is known to those skilled in the art.

Upon positive detection of the interrupting signal (step 410), the transmission is interrupted (step 420). The means for interrupting the transmission in one embodiment include means for instructing the network connection control module 220 to stop the transmission and means for determining the location in the packet of the last datum transmitted. Implementation of the above described means is well known to those skilled in the art. After a predetermined waiting period, transmission re-establishment is attempted (step 430).

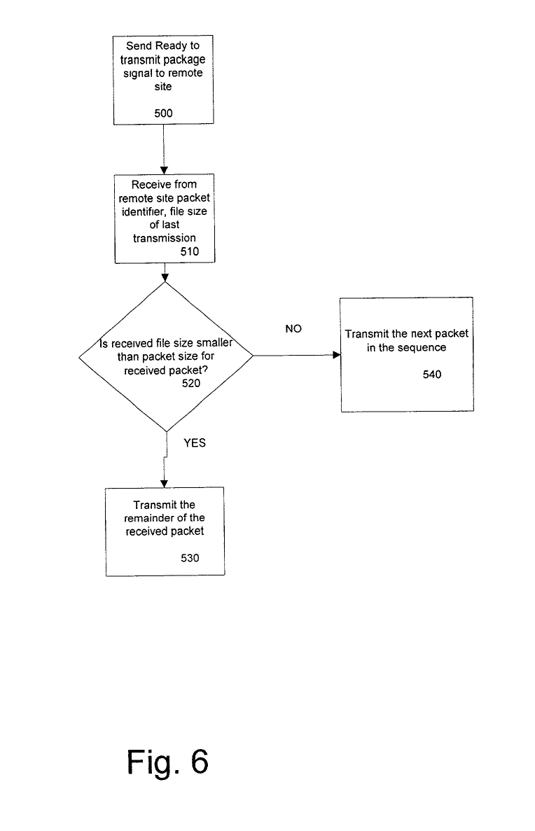

Synchronizing the transmission with the data received at the remote server enables efficient re-transmission. FIG. 6 depicts a flowchart of an embodiment of the method that enables the synchronization of a transmission event with the receiving node so that transmission can restart at the datum immediately following the last datum received at the remote node. In the initial step, at the initiation of a transmission event, a “Ready to transmit” signal is sent to the remote site (step 500). The server at the remote node 5 transmits back to the communications center 2 a packet identifier for the last packet received and the file size of last transmission (step 510) from communications center 2. (In this embodiment, the packet identifier and the file size of last transmission constitute synchronizing information.) The file size of the file received at the remote node during the last transmission is compared to the size of the file for the packet received during the last transmission (step 520) where the comparison is executed by the processor 200 of the communications center 2. If the file size of the file received at the remote node during the last transmission is smaller than the size of the file for the packet received during the last transmission, the remainder of that packet is transmitted (step 530). If the file size of the file received at the remote node during the last transmission is equal to the size of the file for the packet received during the last transmission, the next packet is transmitted (step 540). At the completion of transmission of all packets, a completed transmission indicator is transmitted to the server at the remote node 5. This action will reset the indicators for packet identifier and the file size of last transmission for the specific communications center 2. In this embodiment, the transmission event is synchronized with the information received at the remote node by the above described means. Synchronization between a transmitter and receiver is well known to those skilled in the art and other synchronization methods are known and these are to be included in the spirit of the present invention.

The computer readable code that details the above methods resides in either the ROM or EPROM 230 or the RAM 240 or other storage 250 such as a flash memory or other computer readable medium. It should be apparent to one skilled in the art how to convert the flowcharts to a detailed computer code.

The term “computer-readable medium” as used herein refers to any medium that participates in providing instructions to processor 200 for execution. Such a medium may take many forms, including but not limited to, non-volatile media, volatile media, and transmission media. Non-volatile media includes, for example, optical or magnetic disks or flash EPROM, such as storage device 250. Volatile media includes dynamic memory, such as RAM 240. Transmission media includes coaxial cables, copper wire and fiber optics, including the wires that comprise bus 702. Transmission media can also take the form of acoustic or electro-magnetic waves, such as those generated during radio-wave and infra-red data communications.

Common forms of computer-readable media include, for example, a floppy disk, a flexible disk, hard disk, magnetic tape, or any other magnetic medium, a CDROM, any other optical medium, a RAM, a PROM, and EPROM, a FLASH-EPROM, any other memory chip or cartridge, a carrier wave such as electromagnetic waves (such as used in cellular telephones) or electrical signals (such as those carried in telephone cables), or any other medium from which a computer can read.

### Databases

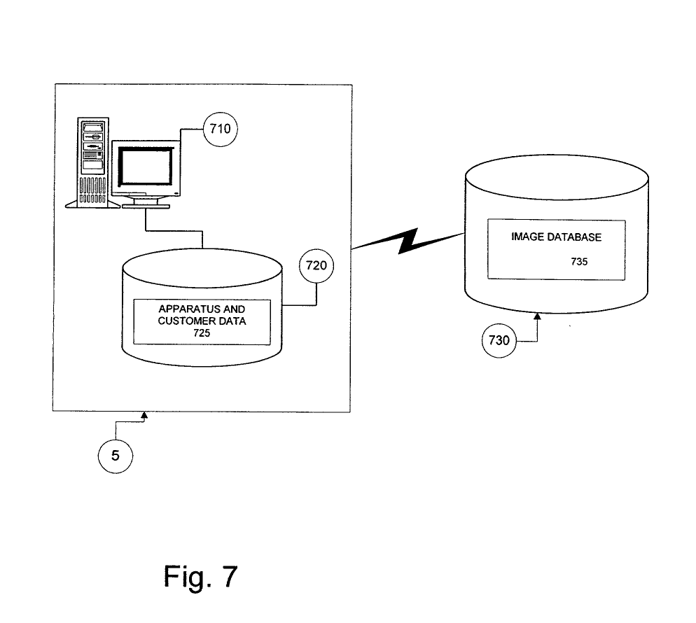

FIG. 7 depicts a graphical representation of an embodiment of the server at the remote node of the network 5 wherein the representation illustrates selected databases. The server at the remote node of the network 5 is represented by a system 710 that includes the components that perform many of the server functions, such as a processor, volatile and non-volatile memory devices, communication modules, a clock, and a data storage device 720 that contains an communications center and customer data database 725. Shown separately, but in communication with the server at the remote node of the network 5, is another data storage device 730 that contains an image database 735. It should be apparent that data storage device 730 can, in one embodiment, be physically the same as data storage device 720 or physically connected to the system 710. In another embodiment, data storage device 730 resides in a back-end server (not shown) in communication with the server at the remote node of the network 5. The server at the remote node of the network 5 could also be in communication with another back-end server (also not shown) where billing and other transaction are processed. Such configurations are known to those skilled in the art.

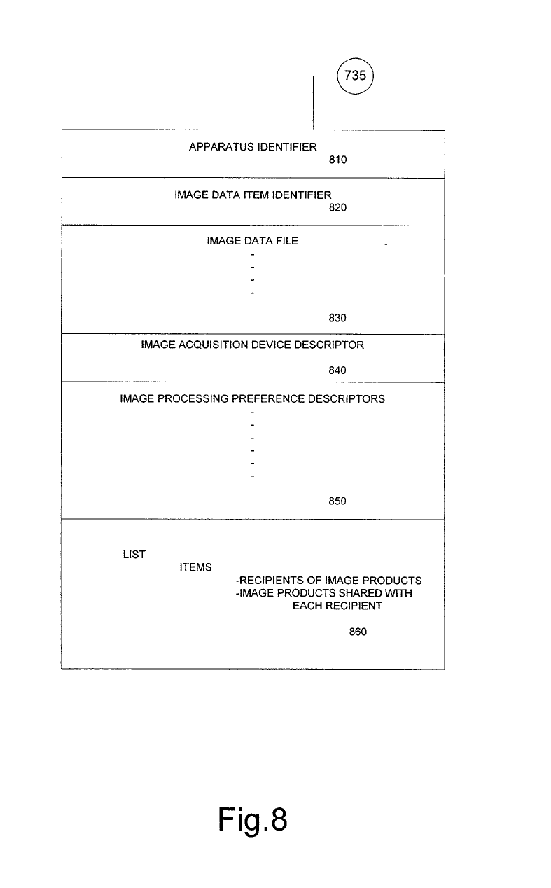

Referring to FIG. 8, the image database 735 comprises the communications center identifier 810, an image data item identifier 820, the image data file 830, the image acquisition device descriptor 840, image processing preference descriptors 850, and a list of the recipients of images or image products and the image products sent to each recipient 860. In one embodiment, the communications center identifier 810 is included in the identifying information that resides in the communication center 2. The image acquisition device descriptor 840 identifies the image acquisition device. Examples of image acquisition identifiers are manufacturer and model number for cameras or scanners. Once the device is identified, its characteristics can be obtained and a device profile can be constructed in the manner described in U.S. Pat. No. 6,128,415 (Hultgren, et al., Device Profiles for Use in a Digital Image Processing System, issued on Oct. 3, 2000), hereby incorporated by reference herein. Then, if hard copy is desired, the method described in U.S. Pat. No. 5,694,484 (Cottrell, et al., System and Method for Automatically Processing Image Data to Provide Images of Optimal Perceptual Quality, issued on Dec. 2, 1997), hereby incorporated by reference herein, can be used to provide an image of optimal perceptual quality rendered by a hard copy output device of known characteristics.

The image processing preferences identified by the image processing preference descriptors 850 include cropping, red-eye removal, color shift, restoration preferences and other processing preferences. The image products that can be sent to each recipient include prints, shared images, framed prints, items (coffee mugs, plates, etc.) with images transferred, clothing with images transferred, and other products containing images.

The image database 735 enables the re-sending of image products, the processing of images without loss of data, the optimal processing of images from the knowledge of the image acquisition device used and provides a record of disposition of images (list of the recipients of images) which the customer can access.

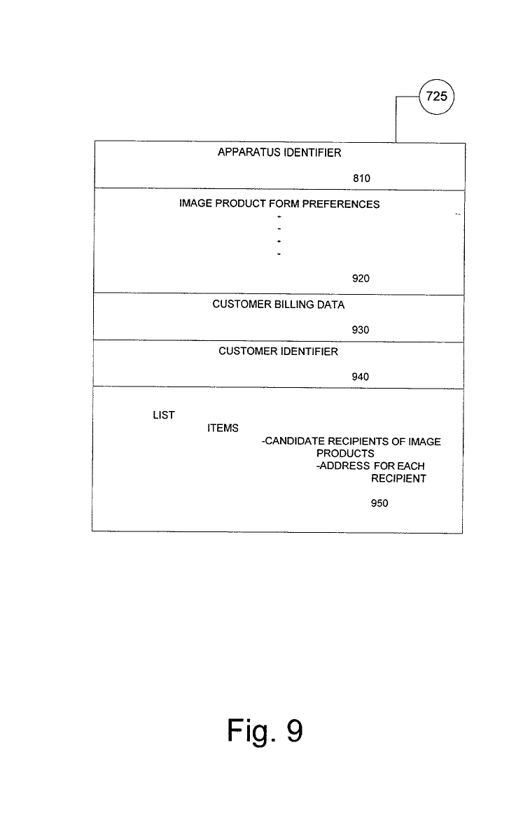

Referring to FIG. 9, the communications center and customer data database 725 includes the communications center identifier 810, a customer identifier 940, image product form preferences 920 corresponding to the identified customer, customer billing data 930, and a list of candidate recipients of image products and an address for each recipient 950. Customer billing data 930 can include credit card information and billing addresses. The customer can access this database using the customer identifier 940. Access to the database 725 allows the customer to modify the image product form preferences 920, customer billing data 930, and a list of candidate recipients of image products and an address for each recipient 950. The customer can access the item in the database 725 by accessing the remote node of the network 5 (a web site in one embodiment). Alternate means of accessing the database 725, such as direct contact with a service organization, can be provided. The communications center identifier 810 used in conjunction with the customer identifier 940 provides a correspondence between the communications center 2 and the customer 10. Note that since the identifying information can be modified in the communications center 2, the correspondence between communications center 2 and customer 10 does not present a difficulty if the communications center is provided to a new customer.

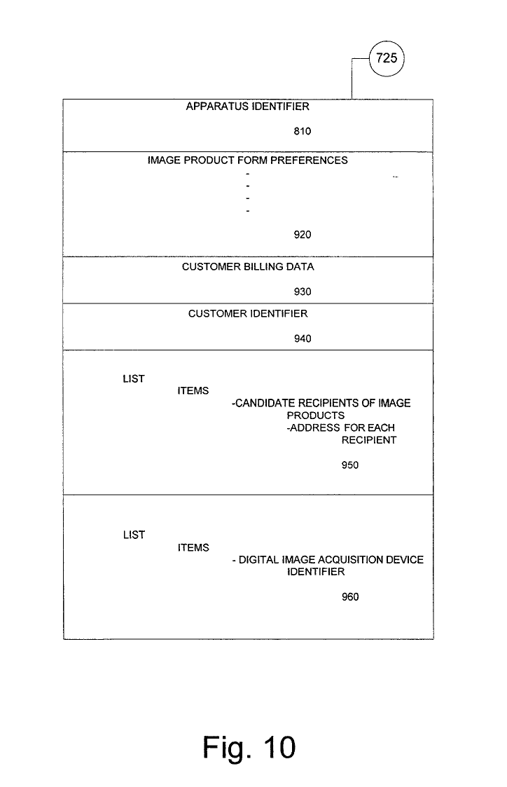

Referring to FIG. 10, database 725 can further comprise a list of digital image acquisition device identifiers 960. The list of digital image acquisition device identifiers provides a list of devices to be profiled so that the method of U.S. Pat. No. 6,128,415 and of U.S. Pat. No. 5,694,484 can be applied to insure optimum quality hard copy.

A system and method to enable the customer to obtain hard copy or digital copy output from or to share or store the digital images by transmitting the images to a remote node of a communication network through an automatically determined closest entry point has been disclosed. Furthermore, methods that enable the transmission of the images to the remote node of a communication network to occur at the fastest data rate, enable the transmission of the images to be interrupted and restarted, and that enable the transmission of the images, after interruption and restart, to restart with datum immediately following the last datum received at the remote node have been disclosed. The databases needed to provide the information so that the disclosed system can provide the best service to the customer have also been disclosed.

Other embodiments of the invention, including combinations, additions, variations and other modifications of the disclosed embodiments will be obvious to those skilled in the art and are within the scope of the following claims.

What is claimed is:

1. A method of transmitting to a remote node in a data communications network, digital images from an image data source, comprising the steps of:
providing the customer a specific apparatus, said apparatus having identifying information stored in a memory thereof; and
accessing and transferring one image or a plurality of images from the image data source;
automatically determining a closest entry point into the data communications network;
transmitting said image or plurality of images and said identifying information, through the closest entry point, to a remote node of the data communications network;
receiving, at the remote node of the data communications network, said image or plurality of images and said identifying information.

2. The method of claim 1 wherein the identifying information is preset in the memory in the apparatus.

3. The method of claim I wherein in automatically determining said entry point GPS information is used.

4. The method of claim 2 wherein in automatically determining said entry point caller ID information is used.

5. The method of claim 1 wherein the communication network is the Internet, the closest entry point is an Internet Service Provider (ISP) and the remote node is a server.

6. The method of claim I wherein the transmission of the image or plurality of images from the apparatus to the remote node of the communication network comprises the steps of:
(A) constructing from each image at least one of a plurality of packets of information wherein the image is comprised of the totality of packets;
(B) transmitting a packet at a given data rate;
(C) determining whether the transmission was successful; and
(D) performing the following steps, if the transmission is successful:
increasing the data rate,
determining if the data rate exceeds a select maximum data rate;
setting the data rate to the maximum data rate, if the data rate exceeds the select maximum data rate;
(E) decreasing the data rate, if the transmission was not successful, until successful transmission is achieved;
(F) transmitting a next packet; and
(G) repeating steps (B) through (F) until the totality of packets is transmitted.

7. The method of claim 1 wherein the transmission of the image or plurality of images from the apparatus to the remote node of the communication network further comprises the steps of:
detecting an interrupting signal; and
interrupting the transmission upon positive detection of the interrupting signal; and
re-attempting transmission after a waiting period following an interruption.

8. The method of claim 7 wherein the transmission of the image or plurality of images from the apparatus to the remote node of the communication network further comprises the steps of:
receiving synchronizing information from the remote node, at the initiation of a transmission event;
synchronizing the transmission event with the information received at the remote node.

9. The method of claim 1 further comprising the steps of:
rendering the least one of said images in hardcopy form at a remote node of the data communications network.

10. The method of claim 1 further comprising the steps of:
rendering the least one of said images in digital form at the remote node of the data communications network.

11. The method of claim 1 further comprising the step of:
storing said image or plurality of images at a remote node of the data communications network.

12. The method of claim 1 further comprising the steps of:
sharing said image or plurality of images, in at least one of a plurality of image product forms, with at least one of a plurality of recipients.

13. The method of claim 1 wherein the identifying information is received at the apparatus and stored in the memory in the apparatus.

14. The method of claim 1 further comprising the step of:
entering items into a data structure in a memory at a remote node of the data communications network.

15. An apparatus enabling the transmission to a remote node in a data communications network, of digital images from an image data source and of identifying information, said apparatus comprising:
means for accessing one image or a plurality of images from the image data source;
means for storing identifying information in a storage component of said apparatus; and
means for automatically determining a closest entry point into the data communications network; and
means for transmitting the image or plurality of images and the identifying information, through the entry point, to a remote node of the network.

16. The apparatus of claim 15 wherein the identifying information relating to the customer is preset.

17. The apparatus of claim 15 further comprising:
means for receiving the identifying information.

18. The apparatus of claim 15 further comprising:
means for installing operating files in said apparatus.

19. The apparatus of claim 15 wherein said means for automatically determining the closest entry point into the data communications network comprise a GPS receiver.

20. The apparatus of claim 15 wherein said means for automatically determining the closest entry point into the data communications network utilize caller ID information.

21. A computer program product comprising:
a computer readable medium having computer readable code embodied therein for enabling transmission to a remote node in a data communications network, of digital images from an image data source and of identifying information, said code causing a computer system to:
acquire image data for at least one of a plurality of images;
obtain data comprising the contact information for a closest entry point into the data communications network;
access data comprising said identifying information;
construct at least one of a plurality of packets of data wherein the data in said at least one of a plurality of packets comprises the image data for at least one image and the identifying information;
establish communication with the closest entry point into the data communications network;
transfer the data in said at least one of a plurality of packets through the entry point, to a remote node of the network at which images are stored or printed.

22. The computer program product of claim 21 where, the computer readable code that causes the computer system to transfer the data further causes the computer system to:
determine whether the transfer of a packet was successful; and
if the transfer is successful, then:
increase the data rate for the transfer of a next packet,
if the data rate for the transfer of a next packet for the transfer of the next packet exceeds a select maximum data rate,
set the data rate to the maximum data rate;
if the transmission was not successful,
decrease the data rate for the transfer of the next packet until successful transmission is achieved.

23. The computer program product of claim 21 wherein in the computer readable code that causes the computer system to transfer the data further causes the computer system to:
identify a presence of an interrupting signal during transfer of a packets of data; and
if the presence of the interrupting signal is identified, then:
interrupt the transfer, and
re-attempt the transfer after a waiting period following the interruption of the transfer.

24. The computer program product of claim 23 wherein in the computer readable code that causes the computer system to transfer the data further causes the computer system to:
at the initiation of a transmission event, receive synchronizing information from the remote node; and
synchronize the transmission event with the information received at the remote node.

25. The computer program product of claim 21 wherein the computer readable code further causes the computer system to:
install operating files in an apparatus, said apparatus including a computer readable medium.

26. A memory for storing data for access by a process executed by a processor, said memory comprising:
a structure for maintaining, at a remote location, image data provided by a customer and other data relating to said customer, said data provided by means of a specific apparatus enabling transmission said image data to said remote location, and said data being available to be shared with at least one of a plurality of recipients in at least one of a plurality of image product forms, said structure including:
an identifier for the specific apparatus;
an identifier for each image datum;
the image datum as provided by the customer;
an image acquisition device descriptor;
at least one of a plurality of image processing preference descriptors;
a list, for said identified image datum provided by means of said identified apparatus, of the recipients of said image datum and of the image product forms that has been shared with said recipient.

27. A memory for storing data for access by a process executed by a processor, said memory comprising:
a structure for maintaining, at a remote location, customer specific data provided by a customer and other data relating to a specific apparatus enabling transmission said image data to said remote location, said structure enabling the sharing of image products, said structure including:
an identifier for the specific apparatus;
at least one of a plurality of image product form preferences;
customer specific billing data;
a list of candidate recipients of image products and addresses for said recipients;
a customer specific identifier.

28. The memory of claim 27 wherein said structure further comprises:
a list of digital image acquisition device identifiers.

29. A method for transmitting an data item or plurality of data items from an apparatus to a remote node of a data communications network comprising the steps of:
(A) constructing from each image at least one of a plurality of packets of information wherein the image is comprised of the totality of packets;
(B) transmitting a packet at a given data rate;
(C) determining whether the transmission was successful; and
(D) performing the following steps, if the transmission is successful:
increasing the data rate,
determining if the data rate exceeds a select maximum data rate;
setting the data rate to the maximum data rate, if the data rate exceeds the select maximum data rate;
(E) decreasing the data rate, if the transmission was not successful, until successful transmission is achieved;
transmitting a next packet; and
(F) repeating steps (B) through (F) until the totality of packets is transmitted.

30. A method for transmitting data from an apparatus to a remote node of a data communications network comprising the steps of:
detecting an interrupting signal; and
interrupting the transmission upon positive detection of the interrupting signal; and
re-attempting transmission after a waiting period following an interruption.

31. The method of claim 30 further comprising the steps of:
receiving synchronizing information from the remote node, at the initiation of a transmission event;
synchronizing the transmission event with the information received at the remote node.
